(19) United States
(12) Patent Application Publication
(10) Pub. No.: US 2008/0177612 A1
(43) Pub. Date: Jul. 24, 2008

(54) Method And System For Designing, Storing, and Executing Workflows For Laboratory Processes

(75) Inventors: Jean Paul Pascual Starink, San Jose, CA (US); John Thomas Kent, Saratoga, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Sciformatix Corporation

(21) Appl. No.: 12/019,491

(22) Filed: Jan. 24, 2008

Related U.S. Application Data
(60) Provisional application No. 60/897,109, filed on Jan. 24, 2007.

(51) Int. Cl. G06Q 10/00; G06F 7/00

(52) U.S. Cl. 705/8; 235/376

(57) ABSTRACT

A method and system for designing, storing, and executing workflows for laboratory processes have been disclosed. According to one embodiment, a computer-implemented method, comprises executing a workflow. The workflow includes a process activity, a system activity, and a flow control activity. A first user interface is adapted to collect one or more process elements for the process activity. The process activity is collected with form elements, the form elements identifying containers. The containers include plates, tubes, and bottles holding samples. States are associated with the samples and containers. The states are automatically changed as the workflow is completed. A second user interface is provided to create a customized workflow.

The present application claims the benefit of and priority to U.S. Provisional Patent Application No. 60/897,109 filed on Jan. 24, 2007, and is hereby incorporated by reference.

### TECHNICAL FIELD

The field of the invention relates generally to networked computer systems, and in particular to a method and system for designing, storing, and executing workflows for laboratory processes.

### BACKGROUND

Workflow management systems are in existence today and provide the ability to automate a process, in whole or in part, that consists of a collection of interactive activities, or steps, and during which information, tasks, and/or documents are passed from one activity and/or participant to another activity and/or participant, based upon a set of specified rules. Workflow management systems are available that have the ability to model laboratory processes. However, current workflow management systems for laboratories require that the generation and management of new workflows be carried out with the assistance of Information Technology (IT) support staff, including, but not restricted to software engineering, software support, and/or application support personnel.

### SUMMARY

A method and system for designing, storing, and executing workflows for laboratory processes are disclosed. According to one embodiment, a computer-implemented method, comprises executing a workflow. The workflow includes a process activity, a system activity, and a flow control activity. A first user interface is adapted to collect one or more process elements for the process activity. The process activity is collected with form elements, the form elements identifying containers. The containers include plates, tubes, and bottles holding samples. States are associated with the samples and containers. The states are automatically changed as the workflow is completed. A second user interface is provided to create a customized workflow.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 depicts a graphical representation of exemplary system entities, according to one embodiment.

FIG. 2 illustrates an exemplary workflow execution, according to one embodiment.

FIG. 3 illustrates an exemplary workflow design and execution computer interaction, according to one embodiment.

FIG. 4 illustrates a graphical representation of an exemplary list of form properties, according to one embodiment.

FIG. 5 illustrates a graphical representation of an exemplary list of item set properties, according to one embodiment.

FIG. 6 illustrates a graphical representation of an exemplary labels property, according to one embodiment.

FIG. 7 illustrates a graphical representation of an exemplary information property, according to one embodiment.

FIG. 8 illustrates a graphical representation of an exemplary mappings property, according to one embodiment.

FIG. 9 illustrates a graphical representation of an exemplary tags, according to one embodiment.

FIG. 10 illustrates a graphical representation of an exemplary tags property, according to one embodiment.

FIG. 11 illustrates a graphical representation of an exemplary workflow, according to one embodiment.

FIG. 12 illustrates an exemplary computer architecture for use with the present system, according to one embodiment.

### DETAILED DESCRIPTION

A method and system for designing, storing, and executing workflows for laboratory processes are disclosed. According to one embodiment, a computer-implemented method, comprises executing a workflow. The workflow includes a process activity, a system activity, and a flow control activity. A first user interface is adapted to collect one or more process elements for the process activity. The process activity is collected with form elements, the form elements identifying containers. The containers include plates, tubes, and bottles holding samples. States are associated with the samples and containers. The states are automatically changed as the workflow is completed. A second user interface is provided to create a customized workflow.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

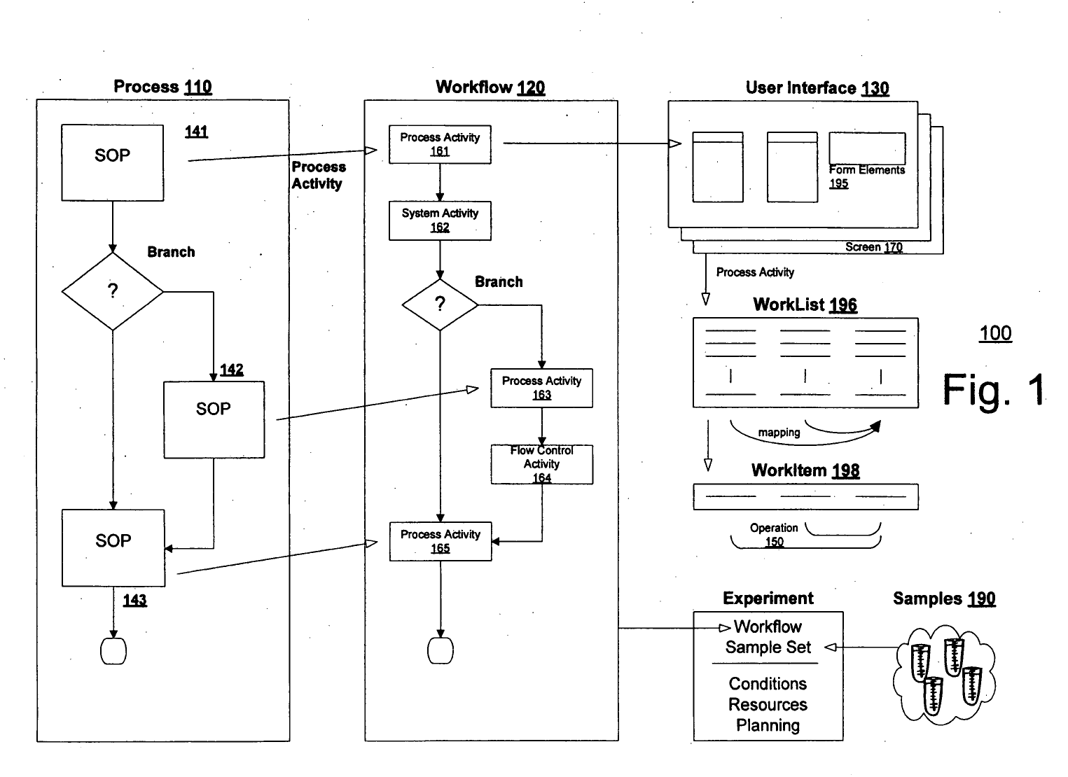

FIG. 1 depicts a graphical representation of exemplary system entities, according to one embodiment. According to one embodiment, a process 110 is an organized laboratory procedure 141-143. The materials and manipulations for each process element 141-143 may be represented by a standard operating procedure (“SOP”) or protocol. A SOP is organized in operations 150. Each process element 141-143 may have an active protocol and is represented by one or more workflow activities 161-165. An organized set of workflow activities 161-165 that are necessary to carry out a process 110 makes a workflow 120. Some workflow activities 161-165 are predefined process elements 141-143 in a workflow 120 that includes business logic functionality which describes a workflow process element 141-143. Process elements 141-143 are mapped directly or indirectly to workflow activities 161-165. Workflow activities 161-165 identify the input and output boundaries of process 110 in a workflow model.

A workflow activity 161-165 may optionally be an automated activity, a manual activity, or some combination of the two. An automated activity is one where no input and no involvement is required from a human being, instead being executed by computers and/or instruments. Non-limiting examples of such activities include: workflow logic, administrative, communication, and logging activities. A manual activity is one requiring the involvement of a human being to perform the activity. A combination automated/manual activity is one that involves some automation and some human involvement.

Different types of activities include process activities 161, 163, and 165, system activities 162, and flow control activities 164. Process activities 161, 163, and 165 are activities that control or participate in operational processes. System activities 162 are automated activities driven by the system, independent of user interactions. System activities 162 are not represented by a lab element or protocol, do not necessarily have a UI representation, and augment the workflow with additional functionality. Examples of system activities 162 may include sending emails to users, rejecting samples according to pre-determined conditions, and putting samples in a different state. System activities 162 thus help laboratory personnel to conduct activities without IT support.

Flow control activities 164 control the flow in a workflow. Based on flow control information or user input, the flow control activity 164 directs the workflow. Examples of flow control activities 164 include activities that repeat one or more activities a number of times, that inspect instrument logs, and activities that allow the operator to select the next activity.

Process activity type 161, 163 and 165 depend on user interaction to complete, thus have a graphical user interface (“UI”) 130 which is also referred to as a Form. The user interface 130 represents a process activity 161, 163 and 165 and presents form elements for executing the process activity 161, 163 and 165, in one embodiment. A UI 130 describes a system of computer screen images, devices, and software components that allow the user to interact with and control the computer's operating system. UI 130 allow the user to interact with the operating system and applications by manipulating icons or menus. Command-line interfaces allow the user to interact with operating systems by entering commands from the keyboard.

UI 130 presents information that is used by a specific process element 141-143, collects and/or displays information for a specific process element 141-143 in the process 110. UI 130 is useful for designing laboratory workflows 120, e.g., Polymerase Chain Reaction (“PCR”), labeling, hybridization, scanning, sequencing, and screening. These forms 130 can be executed independently, providing the user with a way to track unstructured processes, according to one embodiment.

UI 130 may have one or more screens 170 to display and gather workflow activity information through form elements 195. A form element 195 is an element, or control, that resides on the form (e.g., pushbutton, textbox, listbox, other type of panel, etc.) Form elements 195 either display workflow activity 161-165 status information or collect user input for such workflow activity 161-165. Properties of form elements 195 define the functionality and boundaries of information shown and collected as defined by the intended Business Logic Functions (“BLF”). Examples of form elements 195 include Item Sets, Comments, Protocol, Instruments and Tags.

A special form element 195 is a container that represents an identifiable piece of labware such as microtiter plates, tubes, and bottles. Containers and other special form elements, such as resources such as instruments and storage locations, are recognized through a unique identifier (e.g. a barcode label or RFID tag), that is associated with a piece of material or an object used in a laboratory process element 141-143 that is to be tracked throughout the process 110. In this embodiment, items include containers, instruments, and storage locations. Items may be collected in groups, the item set. The item sets identify properties and interactions that add functionalities to UI 130. Different types of item sets include input sets, output sets, and instrument sets, according to one embodiment.

The materials of interest that are to be scheduled and processed by the workflow to complete a process 110 are called samples 190. Workflow state and material state are tracked and are identified by the container or containers that hold the sample 190. Each process 110 that is actually conducted using samples according to a workflow, is an experiment. Experiments follow the workflow elements and may change conditions each time.

Information gathered in the item sets and other form elements 195 is prepared for persistence to a suitable medium, such as an xml file or a database.

Properly defined items of the item sets define a worklist 196 comprising multiple actions, each of which consists of a combination of items from one or more sets. These combinations are defined by business logic, but are generally created from items that line up in the sets. Action represents the smallest granularity to an operator. Operation is the most granular description of work attained by dividing up and mapping onto each other the wells of the action item containers.

Various techniques and technologies and software methods may be utilized in conjunction including, but not limited to, embedding Microsoft development software such as Workflow Foundation (http://msdn2.microsoft.com/en-us/library/ms735967.aspx), and Microsoft robotics (http://www.microsoft.com/robotics), Microsoft SubSonic (http://www.codeplex.com/Wiki/View.aspx?ProjectName-actionpack).

The present system may interact with a wide variety of laboratory machines including liquid handlers, quantitation machines, and chemical reaction machines, in one embodiment. Liquid handlers are machines that move things around, transfer resources from one stage to another. Quantitation machines collect quantity data during an experiment. Chemical reaction machines are the platform where chemical reactions take place.

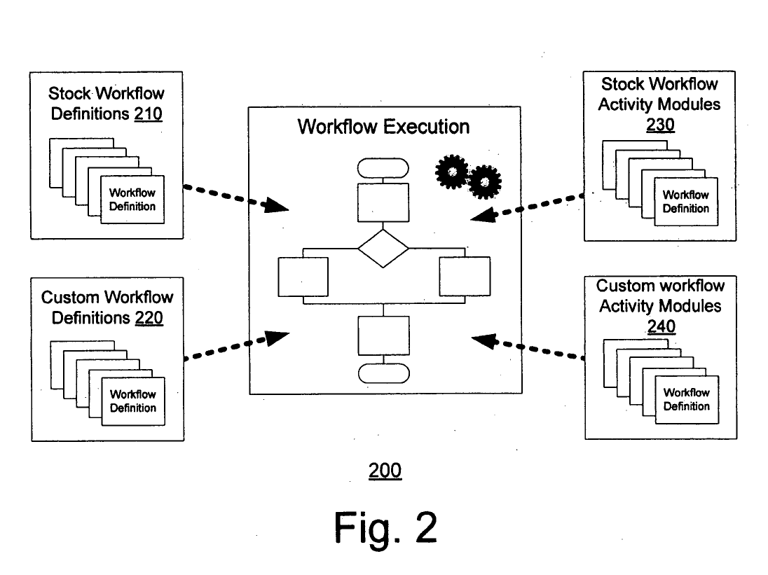

FIG. 2 illustrates an exemplary workflow execution, according to one embodiment. In one embodiment, one or more workflow designs may be made available to users in multiple ways. Stock workflow definitions 210, also referred to as pre-defined workflows, may be provided to users, requiring no additional work in order to execute the workflows. Custom workflow definitions 220 may be created by users, either by creating a custom workflow design from scratch, or by altering an existing workflow design. Then the custom workflows may be executed by users. Stock workflow activity modules 230, also referred as pre-defined workflow activity modules, may be used to build or modify a custom workflow design. The stock workflow activity modules 230 are included in the execution of the workflow, in one embodiment. Additionally, Custom workflow activity modules 240 may be created by users and then used to build or modify a custom workflow design. The custom workflow activity modules 240 are included in the execution of the workflow, in one embodiment.

The workflow can by dynamically defined, in one embodiment. By way of example, the container of an experiment can be a plate, a tube, or a bottle. The workflow provides all these choices so the laboratory technician can easily choose what the container is. The plate option also provides options for different well numbers, in one embodiment.

In addition to the dynamic workflow described in the above embodiment, the present system supports static workflows as well. Static workflows work in situations where a large number of samples are maintained and processed. A static workflow handles storage management, inventory control, and resource planning, according to one embodiment. Such static workflow frees laboratory personnel from manually storing, controlling, and planning a large number of stocks. The present system also provides the option for laboratory personnel to handle such activities manually, if the person chooses to do so.

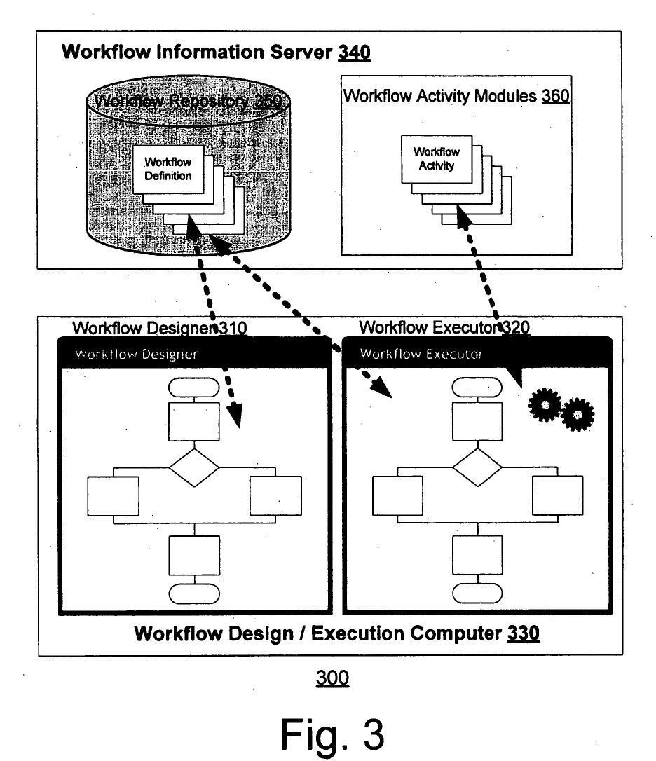

FIG. 3 illustrates an exemplary workflow design and execution computer interaction, according to one embodiment. The workflow designer 310 and the workflow executor 320 interact with the host computer 330 that executes the workflow. The input from the workflow executor 320 to the host computer is a worklist 196, such as a spreadsheet, a database, or a text file, in one embodiment. The host computer 330 runs a script to interpret the worklist 196 and executes the workflow. After execution, the results are picked up by the workflow executor 320 and sent back to the workflow information server 340. The results are stored on the workflow repository 350. The next routine stored in the workflow activity modules 360 is called automatically by the workflow executor 320 subsequently. The workflow and the automatic execution by the execution computer 330 enforce the per-determined process, and automatically informs the laboratory personnel of the next step in the experiment. 0

The present method and system also provides a user with different modes of operation.
Online mode: in one embodiment, a user can utilize an online mode for the operation of this method. The online mode is indicated when a user's execution workstation computers 330 are remotely connected to a workflow information server 340 and the workflow information server 340 holds the primary repository 350 for workstation information. The workflow information server 340 may also provide other services, such as computational processing, during workflow design operations. The workflow information server 340 may be hosted either off-site or on-site.
Offline mode: in another embodiment, a user can utilize an offline mode, also referred to as standalone mode. The offline mode is indicated when a user's workflow design/execution computers 330 handle all necessary options for performing workflow design and/or execution on the individual workflow design/execution computers 330, without being connected to a workflow information server 340. This includes providing a repository 350 for workflow information and computational processing on the workflow design/execution computers 330.
Queued mode: in yet another embodiment a “Queued” configuration is possible. This may include one or more workflow design/execution computers 330 being directly connected to one or more local servers within a user's network, and then the local server(s) being connected a remote workflow information server 340. In this configuration, a user performs work on a workstation computer while connected to a local server, and directs requests (e.g., to save a workflow) to the workflow information server 340 via the local server. The local server forwards requests to the workflow information server 340. The local server may temporarily store (or queue) a request before forwarding it to the workflow information server 340 and await confirmation from workflow information server 340 before removing the request from its queue. The workflow information server 340 provides a repository for saving and retrieving workflows and workflow activities, and may also provide other information as needed by the workstation computer 330 in order to design and/or execute workflows. The local server(s) may maintain a remote connection to a workflow information server 340 or may periodically connect to a workflow information server 340 for synchronization of requests and information. One or more workstations 330 and servers at a given site, across multiple sites for a user, and across multiple users, may simultaneously connect to a workflow information server 340, via local servers, to perform operations. In another embodiment of this same configuration mode, a workstation 330 may be configured to perform as its own local server, storing and forwarding requests to a workflow information server 340.

In one embodiment, the forms can be connected into a workflow using the workflow designer. To achieve tracking of sample and resources through the experiment, mappings are used to indicate how input and output items are related. For a biological process, the granularity of this mapping is based upon sample wells (e.g., well-based containers that hold samples). These wells are the object of tracking in operations.

Form designer: In one embodiment, a UI is generated from a form description. Form designer allows a workflow to define and change form functionality via properties and business rules, thereby creating and modifying form with minimal assistance of a software developer or IT group. The forms and workflows can easily be changed to meet the needs of a dynamic environment.

Experiment designer: In another embodiment, experiments are defined using the Experiment designer. Experiments are minimally based on a workflow and a set of samples, and may include other guidance including conditions, scheduling, and planning. The samples start in the initial sample accepting process element in the workflow, and are guided through the workflow. A user is not required to enforce the form sequence, nor must the sequence itself be fixed. The present system and method allows the user to view how samples proceed through each step of the experiment, so a structured flow is supported if desired. However, the user is free to decide to skip a step, change the path through a workflow, or re-define the workflow during the experiment. In one embodiment an item level inheritance may be supplied through mapping in order to track the well based samples. This concept is meant to unambiguously connect input items to output items, allowing samples to be guided through the steps of the workflow.

Format designer: The present system defines Society for Biomolecular Sciences (“SBS”) standard format containers in the laboratory, such as: (1) tubes; (2) 24-tube rack; (3) 96-well plate; (4) 384-well plate; and (5) 1536-well plate. There may be a need for different formats. Additional formats may be defined in the format designer.

Mapping designer: Uncommon mappings between formats are designed in advance using the mapping designer and used in the form. The user can code functionality that cannot be fully described and included in the form as an add-on using form customization. These customizations may be embedded in the form UI.

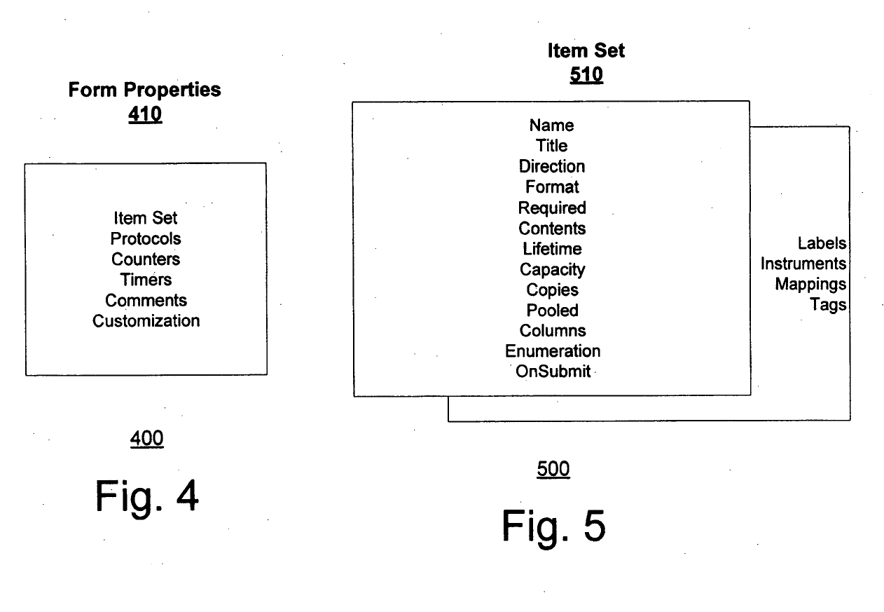

FIG. 4 illustrates a graphical representation of an exemplary UI 130, according to one embodiment. UI 130 enables the user to execute a certain process element 141-143 in a process 110, (e.g. PCR, scanning, sample relocation, DNA sequencing.) Activities in standard workflow design software, are generally designed and coded individually, however, UI 130 is generated from data that describes the functionality of the UI 130 and may be used to generate the UI 130 automatically. The form definition data (“FDD”) describes a wide variety of steps, including common steps in laboratories. The FDD is a description of the form functionality and layout of the form elements. Laboratory people are able to create forms, related BLF, and workflow activities without the need for IT personnel or any knowledge of software design or computer languages.

Form properties 410 may be visualized by a control. A control is a graphical representation and the encapsulation of functionality and business rules of an element in the UI 130. A form property 410 is an item of information that helps to describe or define a form (e.g., comments, protocol addressed, position, size, etc.)

A UI 130 consists of a set of properties 410 and elements 195. By way of example, form properties 410 may include some or all of the details listed and defined below:
Item set: lists of one or more items that are included in, and help define the activities 161-165. The set properties determine much of the functionality and behavior of UI 130.
Protocol: defines a set of appropriate standard operating procedures, or protocols, for the activity.
Counters: serve as informal group identifiers, such as sample sets. The scope can be customarily defined.
Timers: are used to time processes and alert uses about timeouts.
Comments: store comments from the user with the operation and/or items.
Customization: provide events and delegates to promote communication between the form and a customized UI control to augment the functionality of the form.

When a user is scanning barcodes into the item sets on a form, there usually is a preferred order of scanning the different items. The TabOrder defines a series of item sets that the caret focus cycles between. The sets are identified by their names:
ActionMode: determines whether actions behave independently from other actions (Individual), or if an item may be part of more than one action (Array.)
TabOrder: the tab order defines the order in which the items are to be entered.
Layout: the layout of the form can be automatic, guided in which similar elements are grouped, or user defined.

For example, during thermal cycling, there may be three sets: Thermocycler, LeftPlate, and RightPlate. Two plates need to be scanned from a Thermocycler, one for the left and one for the right block. The TabOrder for this form might be: {left PcrPlate, Right PcrPlate, Thermocycler}

FDD instruments that are used in an activity can be tracked. This property can be defined only for Input sets and is optional by default; if no instrument is specified, none is recorded. As with ItemSets, properties define the behavior of the instrument (set). For example, one instrument may be used for all activities, or a different instrument can be specified for each activity. By way of example, properties define the behavior of the instrument set and may include:
Scope: Form, ItemSet, Action, Operation.
Name: the set identifying name.
Title: title or description to display.
Presence: whether instrument identification is Required or Optional.
Capacity: number of instruments expected, either One or Many.
Copies: allowed number of copies of the same instrument, either Single or Multiple.

In form scope, one instrument is associated with all operations, while in ItemSet scope each input/output set combination is assigned an instrument. In action scope, each action is associated with an instrument.

FIG. 5 illustrates a graphical representation of an exemplary item set, according to one embodiment. Input from the user is grouped in item sets 510. The appearance and behavior of the item set are determined by the set's properties:
Name: unique in the scope of the UI 130 to identify the set.
Title: description that is shown on top of the input field.
Direction: defines whether and how the following fields will be used: input, output, or new is items will have to be created.
Format: denotes the expected format of the items. If the format field is left empty, any format will be accepted.
Required: indicates whether the presence of items in this item set if required or optional for the activity.
Lifetime: As a result of the activity, an item may become invalid (discard), live on (stay), or its contents may transition into something else as defined by this property.
Capacity: indicates how many items are to be expected. This may take the form of a quantitative value (a specific numeric value) or a qualitative value (e.g., Single of Many.)
Copies: defines whether multiple copies of the same item are allowed.
Pooled: items entered may participate in individual activities or the intention may be to pool the item (e.g. for reagents.) This property indicates whether an item is to be Pooled (True) or participate Individually (False.)
Columns: items in a set are displayed in a worklist 196. The columns collection specifies which tags and/or properties are shown for an item. The default is a single column with the barcode.
Enumeration: the manner in which wells are enumerated within a container. The values include RowCol, Colrow, or Index.
OnSubmit: determines whether the items in the worklist 196 are to be cleared or kept on successful execution of the activities.

In one embodiment, actions are independent of one another, and items may be mapped to items within the same action—sibling items. Containers included from different actions may have impact on the FDD and is defined by the FormAction property, which can be Individual or Mixed. Examples of Mixed forms include moving tubes into plates, which is referred to as Merger, or moving from plates into tubes, which is referred to as Split.

In one embodiment the flowing rules may apply for Mixed forms:
There may be exactly one Input and one Output item set.
One of the sets may have a capacity of One, the other a capacity of Many.
The item index defines the well involved in the operation.
The wells in the format are enumerated row/col, col/row, or by index.

Item set properties can also be organized as composite properties defined by BLF pertaining to elements already defined on the form. By way of example, item set properties may include:
Labels: defines the layout and fields of items barcode labels. It must be supplied for New items, and is optional for existing Output items.
Instruments: instruments involved in the actual operation can be tracked, provided they have specific identifiers (e.g., a barcode.)
Mappings: in order to track individual well samples, mappings are defined that link input to output wells. Mappings are defined for each Input set with the Output set.
Tags: tags are stored with items and operations, and may be a combination of inherited info tags belonging to the parent items and user supplied info tags. In one embodiment, info tags may be organized as key/value pairs.

Upon form submission, actions are created by combing items from the various item sets. The first step is to replace for each pooled set the items with a single pooled item. The row items of the individual sets that line up are joined with all pooled items, so each action involves all items of all pooled sets. Once the actions are defined, operations are created for each input/output pair in the action. These operations are grouped and identified by a unique action identifier. In one embodiment, each action is independent of other actions, and the items may be mapped to items within the same action. This is a form property as opposed to a set property, and is considered to be independent mode. In mixed mode, a container may belong to different actions, for example when arraying tubes into a single microtiter plate. An independent form has by either only one item set, which by default is InOut, or one or more Input sets and exactly one either Output or New set. The items in a Output set must exist, while for a New set, labels must be defined and will be printed upon completion of the form. A mixed form may have exactly one input and one output set, either Output or New. The label rules for the output set are the same as for the independent form.

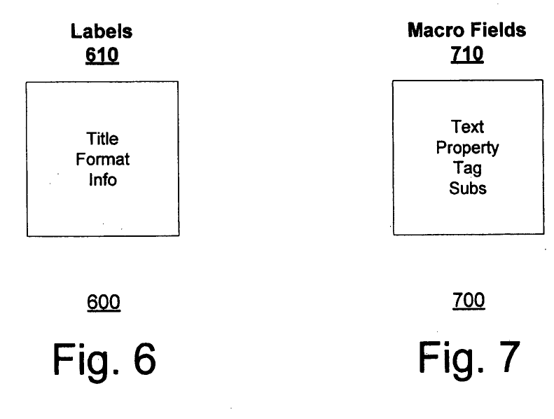

FIG. 6 illustrates a graphical representation of an exemplary labels property, according to one embodiment. For new Output sets, and if specifically defined for a input set, the system will print labels 610. A label definition must be supplied for all items in the set and is created from information from items participating in the action. In addition to the text definitions meant for human identification, a label 610 is provided with an identifier that is unique, represented by a format amenable to automated scanning, such as barcodes or RFID. A label 610 may have a set of properties. By way of example, label properties and their definitions may include:
Title: the title of the label indicates the operation that created it. By default, this is the name of the form operation, but this may be changed by the user.
Format: indicates the style of the label.
Info: is a collection of macros that defines additional label information.

Info consists of a collection of macros. These macros are used in many parts of the FDD to collection information to be processed. For example, lines on barcode labels and item tag inheritance are defined by macros. A macro may be composed of an arbitrary combination of fields. By way of example, FIG. 7 illustrates a graphical representation of exemplary macro fields 710, according to one embodiment. The fields may include
Text: literal text is defined by enclosing the text in quotes, e.g., “Master Mix” or “Biopsy Sample”.
Property: properties of sibling items in the action are available by scoping the tag key with the set name, e.g., Sample.Type or Instrument.Name.
Tag: Tags of sibling items are available by scoping the tag key with the set name.
Subs: substitution macros are enclosed in $ characters. In the current context, by way of example, subs may include the following:
$Date$: the current date
$DateTime$: the current date and time
$User$: name of the user
$ItemIndex$: the 1-offset index of the item in the set
$Well$: the well position in the plate, printed as indicated by the Enumeration property. For example, a MasterMix is created using a sample from item set Sample, a PCR Cocktail from set PcrReagent, and PCR primer plate from set PcrPrimer. A plate label definition can be defined as follows:
“Master Mix” ‘-’ Sample.Name
PcrReagent.Name ‘-’ PcrPrimer.SetId
$User$-$Date$

Samples are tracked on a well basis. This is achieved through mappings, which describe the association between input and output wells in an operation. Given the standard formats—Tube, Plate96, Plate384, and Plate 1536—default mappings are available in the following cases:

| | Tube | Plate96 | Plate384 | Plate1536 |
|---|---|---|---|---|
| Tube | ✓ | ✓ | ✓ | ✓ |
| Plate96 | ✓ | ✓ | — | — |
| Plate384 | ✓ | — | ✓ | — |
| Plate1536 | ✓ | — | — | ✓ |

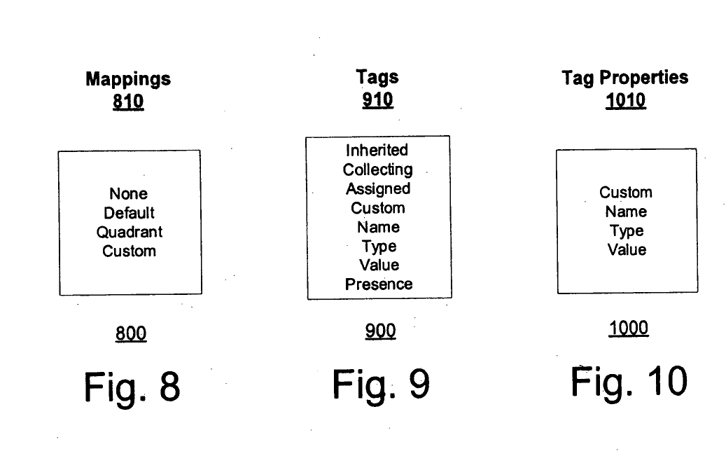

Mappings between identical formats are apparent. For example, the mapping between a tube and a plate is defined by mapping the tube well to all plate wells, and mapping between identical formats are simply by well index. The mappings between different format plates cannot be resolved by default. To resolve this, different mapping modes can be defined. By way of example, FIG. 8 illustrates a graphical representation of an exemplary mappings property, according to one embodiment. Mapping 810 modes may include:
None: there is no need for well mapping, and therefore there are no operations between the items.
Default: most operations have a simple mapping. These standard mappings are the default and will suffice in many situations. As explained above, there are 10 default mappings for the predefined item formats
Quadrant: when operations involve different plate formats, e.g., 96 to 384, commonly the smaller plate is mapped to a quadrant of the bigger one. These are called quadrant mappings, and are accessible directly in the Form Designer.
Custom: when a non-standard well mapping is needed, the user may define the mapping in advance using a mapping designer.

For each input set a mapping 810 must be defined with the output set. Be default, these mappings 810 are picked from the default mappings. The user may define additional mappings 810 and arrange the order of the mappings 810 attempted for the format pair. The system will try the mappings 810 sequentially until a compatible mapping 810 is found. When none is available, the format combination is considered invalid and will be rejected by the form upon validation.

In one embodiment, a plate is used to perform PCR. This plate can be barcoded. A barcode label, including a unique barcode and optional text, is generated (printed) for this plate and affixed to the plate. The barcode label contains information including the steps performed on this plate, size of the plate, and mapping information. In this embodiment, one reagent is added to each well of the plate for DNA extraction. The extracted DNA is then transferred to a different plate that is also barcoded for PCR. The mapping between the two plates is recorded. More steps may be executed, and mapping of the wells on the plates is always recorded.

Forms present and collect information from the user that are not necessarily essential to the form. However, this information may represent process information, like transfer volume or emission frequency. This information is referred to as Tags. In one embodiment, tags are organized as key/value pairs. Tags are defined and can be read for all sets, but can be assigned to the output set only. There may be different types of tags. By way of example, FIG. 9 illustrates a graphical representation of an exemplary tags property, according to one embodiment. Tag 910 types may include:
Inherited: inheriting tags from items is realized by scoping the tag with the set name. For example, when printing a barcode label for a sequencing chip, the dye's emission wavelength may be referenced as Label.Wavelength. Note that scoping automatically selects the sibling item(s) in the action.
Collecting: Collecting tags are tags for the user to fill out. This presence of the information upon submission can be set to required or optional.
Assigned: Assigned tags receive a predefined value upon submission. For example, when two different forms are available for a certain activity, an assigned tag can be used to tell which one was actually used.
Custom: a need may arise to gather information that has not already been defined as a tag. In this case, the user may define a tag ‘on the fly’, which then becomes a collecting tag. This tag may scope information of items in the same action, and may even use other custom tags.

The Inherited, Collecting, and Assigned tags are design-time tags, while the Custom tags are run-time tags.

Tags 910 may propagate information, or provide a powerful way to impose constraints. Through this mechanism, items can be accepted or rejected based on the value of a specific tag it owns. Similar to items, tag behavior and functionality is driven by its properties. By way of example, FIG. 10 illustrates a graphical representation of an exemplary tags property 1000, according to one embodiment. Tag properties 1000 may include:
Custom: whether custom tag definition is allowed. Its value can be either Yes or No.
Name: the name of the tag.
Type: the type of the tag: Inherited, Collecting, or Assigned.
Value: the value must be scoped for Inherited, may contain a default value for Collecting, and must have a value for Assigned tags.
Presence: applies only to Collecting tags. Its value can be either Required or Optional.

Although instruments are technically not item sets, they may expose tags like Name, Type, and Barcode, which may be sued by scoping the tag with the name of the Instrument set.

If protocols are available for a process step, configuration steps can be taken to allow the user to specify the version of a protocol that was used.

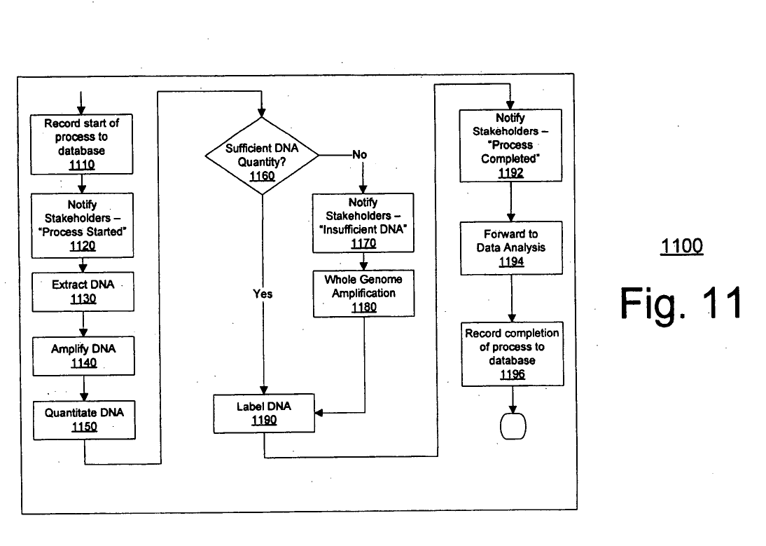

FIG. 11 illustrates a graphical representation of an exemplary workflow, according to one embodiment. It represents an example of a process workflow 1100 for processing and matching DNA samples. The workflow includes both Process Activities, such as “Extract DNA” 1130, Systems Activities, such as “Notify Stakeholders” 1120, and Decision Activities, here represented by the QC step “Sufficient DNA Quantity?” 1160.

In one embodiment, there are three different types of activities in a workflow: System Activities 162, process activities 161, 163, and 165, and flow control activities 164.

A system activity 162 is an activity for which the work is performed independent of and without input from an operator. Examples of system activities 162 include sending email, and instrument monitoring. A system activity 162 is started by an event, either internal or external. Examples of internal events include completion of a previous activity, expiration of a timer attached to an operation, and the occurrence of a system error. Examples of external events include the completion of a step by an instrument, sign-off notification by a supervisor, and process state events such as pause and resume.

Process activities 161, 163, and 165 are activities that are created to represent a process element in the process 110. If an SOP is in place, a process activity 161, 163, and 165 implements and therefore closely resembles a step in the SOP. Process activities 161, 163, and 165 have a UI 130 and interact with an operator to record process step related information, and are submitted for processing by the system.

Flow control activities 164 are activities that control the activity flow. Based on information, either internal or external, the activity makes a decision on where to direct the workflow for the next activity. Examples of flow control activities 164 that base their decision on internal information include activities that repeat one or more activities a fixed number of times, or that checks the time elapsed to prevent either premature or delayed processing. Examples of flow control activities 164 that use external information include activities that inspect instrument logs, and activities that allow the operator to select the next activity.

To maintain a chain of custody, the system 100 records information associated with activities performed. For example, when sample transfer is performed from one container to another one, the system 100 will record, at a minimum, the source and destination containers, the wells associated with the containers, how much material was moved, operator information, and a timestamp. Based on the form definition, extra information may be recorded that is related to the instrument involved, such as the barcode, type and model, and operator.

Some instruments, in particular liquid handling robots, use a worklist 196 to define the task, in which a workitem 198 describes a basic transfer that the robot instrument software can be programmed to understand. For example, a worklist 196 may look similar to the following table:

| | Source | Source | Destination | Destination | Transfer |
|---|---|---|---|---|---|
| Task Nr | Barcode | Well | Barcode | Well | Amount |
| 1 | dev1004 | 1 | dev2303 | 1 | 25 |
| 2 | dev1004 | 3 | dev2303 | 2 | 25 |
| 3 | dev1004 | 5 | dev2303 | 3 | 25 |
| 4 | dev1004 | 7 | dev2303 | 4 | 25 |
| 5 | dev1004 | 9 | dev2303 | 5 | 25 |
| 6 | dev1004 | 21 | dev2303 | 6 | 25 |
| 7 | dev1004 | 27 | dev2303 | 7 | 25 |
| 8 | dev1004 | 33 | dev2303 | 8 | 25 |

This worklist 196 is created after an activity has been submitted, and stored in the activity job queue.

To record the actions performed to complete the process steps 141-143, the following three embodiments are common:

Trusted: No verification can be done to assure the proper operation has taken place. For example, if an operator uses a pipette to transfer the sample 190, guaranteed verification is impractical. In this embodiment a sign-off procedure is put in place. The embodiment of submitting a work to an instrument's control software is another example of trusted verification.

Implicit verification: If the system 100 has full control over the instrument involved in the activity, the work is initiated and executed by the instrument. In this case, operators will have no way of changing the work items 198 outside the system 100, and therefore their execution will be verifiable.

Joint verifications: A description of work is submitted that is to be interpreted by the instrument's control software. In order to increase traceability, the system 100 needs to assure the worklist 196 offered to the robot for the particular job is truly the list that was submitted. Many types and brands of instruments produce an operation log that can be read by other applications for these purposes. This log can be verified to ensure the operations executed by the instrument match the items in the work description submitted.

The implicit verification embodiment is optimal, but in most cases not viable since custom control software needs to be developed for each new instrument used. The joint verification will ensure the correctness of the activity execution, and may have the benefit of discovering instrument errors. Implementation of instrument specific scripts to interpret the worklist 196 and software to read the instrument logs are likely to be much less complex that the software needed for implicit verification.

FIG. 11 represents an example of a process workflow for processing and matching DNA samples, according to one embodiment. This process, for example, may be used for paternal testing. The workflow 1100 includes system activities, process activities, and a flow control activity. Following are descriptions of these activities.

System Activity—Record start of process to the database 1110. The first activity, record start of process 1110, is triggered by an external event. In this case, the event is triggered based on the availability of the samples 190, the successful processing of a payment, and the availability in the laboratory scheduling. A laboratory information management system (LIMS) changes the status of the project from its current status to the ‘Active’ status.

System Activity—Notify Stakeholders 1120. At several points in the process, the system 1100 will notify stakeholders about the progress of the process. This information may serve as passive reporting communication, but may also invite a response that affects the flow of the process. In this step, a notification is sent out to stakeholders that the process has been activated. In particular, an email is sent to the doctor ordering the test, and a task notification is sent out to the lab manager to assign resources to the process.

Custom Activity—Extract DNA 1130. After the lab manager has assigned resources, in particular operators, to the process, the first step in the workflow is to extract the DNA 1130 from the blood. The operator, upon loading the UI 130, scans in the barcode of one the blood tubes associated with the order. In this order there will be at least one tube associated with the individual, and at least one tube associated with the contested parent. One of the business logic rules for this step is that the parent blood cannot be processed in the same step as the individual's blood to avoid cross contamination of the samples. The actual extraction of the DNA from the blood can be performed using a commercially available kit, in one embodiment. This kit can be received and barcoded in advance and the operator scans the blood tube barcode and the kit barcode. Upon submission, the system 1100 will print a barcode label that the operator will affix to the product tube holding the DNA after extraction. Upon submission of the form, the system 1100 will queue the DNA tube for the next step.

Custom Activity—Amplify DNA 1140. In order to read the DNA markers used in the analysis, many copies of the DNA need to be made of the regions that contain these markers. Such process is called PCR. This process makes copies by cycling the temperature of the sample, effectively denaturing the DNA into two single strands when heating up and annealing into two separate dual strands upon cooling down. The operator will scan the barcode of the DNA tube that resulted from the previous step and the barcode of a tube containing the PCR reagents. In addition, the barcode of the thermocycler, the machine that cycles the temperature of the sample, is scanned. The control software of the thermocycler records the heating and cooling patterns of the sample which is read after the step is complete, and verified for accuracy. The result of this step is a tube with amplified DNA that is now queued for the next step.

Custom Activity—Quantitate DNA 1150. One requirement for the analysis to be successful is that the amount of DNA after amplification exceeds a certain minimum level. At this point in the process, a quantitation step is performed to decide if the amount of product of the amplification is sufficient. The most commonly used technique for measuring nucleic acid concentration is the determination of absorbance at 260 nm (A₂₆₀). A small amount of DNA is mixed with a working solution of PicoGreen reagent, prepared in advance. After incubation of 10 minutes, for which an event timer is set, the tubes are inserted in a fluorometer that reads the concentration of the DNA and outputs this information to a text file. The fluorometer used is a Tecan for which custom control software is available. This means that both the job execution and the result retrieval can occur automatically.

In this activity, the operator scans the tube with amplified DNA, and a tube with working concentration PicoGreen that has been prepared ahead of time. The SOP requires the operator to also scan the barcode label on the Tecan to appropriately queue the job. After transferring a small amount of DNA to the PicoGreen tube, the system 1100 alerts the operator after 10 minutes of incubation time that the tube needs to be scanned. UI 130 will guide the user through this process. Then the system 1100 retrieves the Tecan output and attaches the measurements to the sample in the database.

Flow Control Activity—DNA Quantity 1160. The purpose of the flow control activity 1160 is to determine whether sample amplification yield was sufficient. If not, an additional process step needs to be performed. The conditional step is configured to test the Quantity property of the sample 190 offered, and determine if the sample 190 may continue the normal route, or if it needs to go through the additional whole genome amplification (WGA) step. WGA amplification is a sure way to amplify ample DNA from a small sample, but is also very expensive. That's why this process starts with the cheaper PCR method and only performs WGA when needed. Based on the quantity of DNA, the sample is put either in the Label DNA queue or the WGA queue.

System Activity—Notify Stakeholders 1170. In this activity, the stakeholders are notified that the PCR amplification did not yield sufficient product, and an additional WGA needs to be performed. The stakeholders include the lab manager, who may want to inspect the PCR result before authorizing the WGA step. For example, if the yield was very low, this may indicate something is wrong with the sample, an indication that WGA will be ineffective. Another stakeholder may want to prepare materials in anticipation of the next step.

Process Activity—Whole Genome Amplification (“WGA”) 1180. If the PCR amplification does not yield sufficient product, an additional WGA step needs to be performed. Authorized by the manager, in this step, similar to the DNA Extraction step, the user will scan the barcodes on the tube of amplified DNA and the WGA kit. The system will then print a label to be affixed to the tube ultimately holding the WGA DNA.

Process Activity—Label DNA 1190. After amplification, the different DNA fragments are analyzed using analyzer, for example an Agilent Bioanalyzer. The protocol for this step required the fragments to be stained (similar to PicoGreen), and labeled with a DNA dye. The required reagents are purchased in kit form, and the kit is labeled with a barcode. The operator scans in the tube with amplified DNA, and the kit barcode label. Unlike the Tecan, there is no control of the instrument from within the present system, and the system relies on SOP adherence. The user is issued a run name, which needs to be entered into the Bioanalyzer's software. A component in the system, the directory watcher, times the operation and watches a directory for the Bioanalyzer file to show up. Upon inspection of the results, it then will mark the operation as successful. This will transition the workflow to the next step.

System Activity—Notify Stakeholders 1192. The activity Notify Stakeholders “Process Completed” is triggered by the workflow entering this step. A notification is sent out to stakeholders that the process has been completed. Here, an email is sent to the doctor who ordered the test with information on when the results will be available, and a task notification is sent out to the lab manager to release the resources.

System Activity—Forward results to be analyzed 1194. After notification, the results, e.g., samples with the attached Bioanalyzer results, are forwarded to the analysis phase. This phase is performed outside the LIMS.

System Activity—Record start of process to the database 1196. Finally, after successful completion of all process steps, the system 1100 will change the status of the project from its current status to the ‘Complete’ status. This will allow the lab manager to reassign resources needed for the next process in the queue.

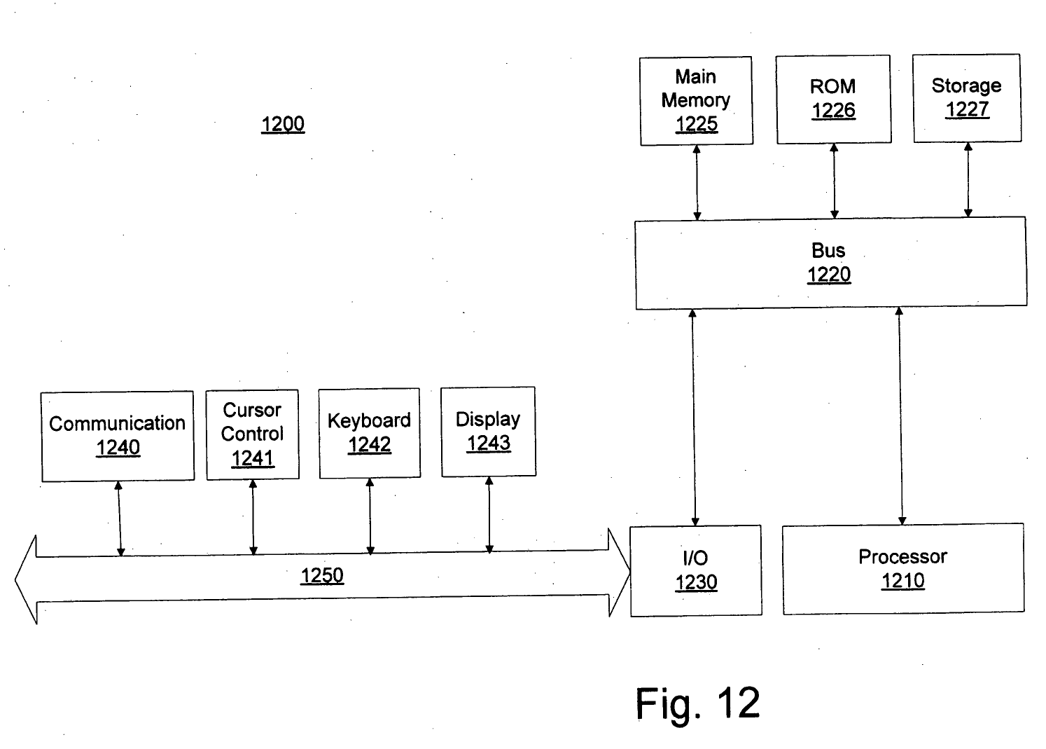

FIG. 12 illustrates an exemplary computer architecture for use with the present system, according to one embodiment. One embodiment of architecture 1200 comprises a system bus 1220 for communicating information, and a processor 1210 coupled to bus 1220 for processing information. Architecture 1200 further comprises a random access memory (RAM) or other dynamic storage device 1225 (referred to herein as main memory), coupled to bus 1220 for storing information and instructions to be executed by processor 1210. Main memory 1225 also may be used for storing temporary variables or other intermediate information during execution of instructions by processor 1210. Architecture 1200 also may include a read only memory (ROM) and/or other static storage device 1226 coupled to bus 1220 for storing static information and instructions used by processor 1210.

A data storage device 1227 such as a magnetic disk or optical disc and its corresponding drive may also be coupled to computer system 1200 for storing information and instructions. Architecture 1200 can also be coupled to a second I/O bus 1250 via an I/O interface 1230. A plurality of I/O devices may be coupled to I/O bus 1250, including a display device 1243, an input device (e.g., an alphanumeric input device 1242 and/or a cursor control device 1241).

The communication device 1240 allows for access to other computers (servers or clients) via a network. The communication device 1240 may comprise a modem, a network interface card, a wireless network interface or other well known interface device, such as those used for coupling to Ethernet, token ring, or other types of networks.

A method and system for designing, storing, and executing workflows for laboratory processes have been described. It is understood that the embodiments described herein are for the purpose of elucidation and should not be considered limiting the subject matter of the present patent. Various modifications, uses, substitutions, combinations, improvements, methods of productions without departing from the scope or spirit of the present invention would be evident to a person skilled in the art.

We claim:

1. A computer-implemented method, comprising:
executing a workflow, the workflow including a process activity, a system activity, and a flow control activity;
providing a first user interface that is adapted to collect one or more process elements for the process activity;
collecting the process activity with form elements, the form elements identifying containers, the containers including plates, tubes, and bottles holding samples;
associating states with the samples and containers;
automatically changing the states as the workflow is completed; and
providing a second user interface to create a customized workflow.

2. The computer-implemented method of claim 1, wherein the workflow is a custom workflow.

3. The computer-implemented method of claim 1, wherein the flow control activity comprises:
receiving a worklist;
interpreting the worklist; and
generating a first output.

4. The computer-implemented method of claim 3, further comprising initiating the system activity to notify a user via e-mail of a result, the result including progression to a second process activity.

5. The computer-implemented method of claim 3, further comprising storing the first output in a workflow repository.

6. The computer-implemented method of claim 1, further comprising generating unique barcodes for each of the containers.

7. The computer-implemented method of claim 6, wherein scanning the barcodes triggers a second process activity that is part of the workflow.

8. The computer-implemented method of claim 1, wherein the custom workflow is generated by modifying the process activity, the system activity, and the flow control activity.

9. The computer-implemented method of claim 1, wherein the custom workflow is generated from scratch.

10. The computer-implemented method of claim 1, wherein the first user interface is generated from meta-data provided to the second user interface.

11. The computer-implemented method of claim 1, wherein the process activity, the system activity, and the flow control activity follow a sequence and the second user interface allows the sequence to be modified and additional activities to be added.

12. The computer-implemented method of claim 1, wherein the customized workflow can be designed and executed using one or more configurations, the configurations including online, offline, and queued.

13. A computer-readable medium having stored thereon a plurality of instructions, the plurality of instructions when executed by a computer, cause the computer to perform:
executing a workflow, the workflow including a process activity, a system activity, and a flow control activity;
providing a first user interface that is adapted to collect one or more process elements for the process activity;
collecting the process activity with form elements, the form elements identifying containers, the containers including plates, tubes, and bottles holding samples;
associating states with the samples and containers;
automatically changing the states as the workflow is completed; and
providing a second user interface to create a customized workflow.

14. The computer-readable medium of claim 13, wherein the workflow is a custom workflow.

15. The computer-readable medium of claim 13, wherein the flow control activity comprises:
receiving a worklist;
interpreting the worklist; and
generating a first output.

16. The computer-implemented method of claim 15, having stored thereon additional instructions, the additional instructions when executed by a computer, cause the computer to further perform initiating the system activity to notify a user via e-mail of a result, the result including progression to a second process activity.

17. The computer-readable medium of claim 15, having stored thereon additional instructions, the additional instructions when executed by a computer, cause the computer to further perform storing the first output in a workflow repository.

18. The computer-readable medium of claim 18, having stored thereon additional instructions, the additional instructions when executed by a computer, cause the computer to further perform generating unique barcodes for each of the containers.

19. The computer-readable medium of claim 18, wherein scanning the barcodes triggers a second process activity that is part of the workflow.

20. The computer-readable medium of claim 13, wherein the custom workflow is generated by modifying the process activity, the system activity, and the flow control activity.

21. The computer-readable medium of claim 13, wherein the custom workflow is generated from scratch.

22. The computer-readable medium of claim 13, wherein the first user interface is generated from meta-data provided to the second user interface.

23. The computer-readable medium of claim 13, wherein the process activity, the system activity, and the flow control activity follow a sequence and the second user interface allows the sequence to be modified and additional activities to be added.

24. The computer-readable medium of claim 13, wherein the customized workflow can be designed and executed using one or more configurations, the configurations including online, offline, and queued.
